(19) United States
(12) Patent Application Publication
(10) Pub. No.: US 2021/0096901 A1
(43) Pub. Date: Apr. 1, 2021

(54) SHARED MEMORY BUFFERS TO SUBMIT AN INTERRUPT REQUEST WORKLIST TO A BACK END VIRTUAL MACHINE

(71) Applicant: QUALCOMM Incorporated, San Diego, CA (US)

(72) Inventors: Liang Xia, Thornhill (CA); Peter Koster, Toronto (CA)

(21) Appl. No.: 16/590,176

(22) Filed: Oct. 1, 2019

(51) Int. Cl. G06F 9/455; G06F 13/24

(52) U.S. Cl. CPC G06F 9/45558; G06F 2009/45579; G06F 13/24

(57) ABSTRACT

A shared memory may be employed for use with a front end (e.g., a guest virtual machine (GVM) component) and a back end (e.g., native driver, physical virtual machine (PVM) component, hardware, etc.) of a virtualization system to allow the front end to influence (e.g., control) the occurrence of the virtual interrupt request (IRQ) forwarding from the back end. The shared memory may include one or more flags or one or more lists to allow the front end to control the behavior of the back end virtual IRQ forwarding logic without causing the back end to stop its existing processes. Thus, the front end may multiple numerous input/output (IO) requests, but the front end may only check the completion of some of the requests (e.g., based on work items written into the shared memory, by the front end, for back end processing and back end IRQ forwarding).

### BACKGROUND

The following relates generally to virtualization, and more specifically to shared memory buffers to submit an interrupt request (IRQ) worklist to a back end virtual machine (VM).

Among the advantages of virtualization and VM technology is the ability to run multiple VMs on a single host platform. This makes better use of the capacity of the hardware, while still ensuring that each user enjoys the features of a “complete” computer. Depending on implementation, virtualization may also provide greater security, since the virtualization may isolate potentially unstable or unsafe software so that it cannot adversely affect the hardware state or system files required for running the physical (as opposed to virtual) hardware.

### SUMMARY

In some implementations, virtualization may be employed to perform various computing tasks, such as tasks in the form of a front end (e.g., a guest virtual machine (GVM) component) submitting hardware requests to a back end (e.g., a physical virtual machine (PVM) component). For example, a GVM component of a device may submit input/output (IO) requests to a PVM component of the device, and the PVM component may execute hardware operations (e.g., draw frame operations, display frame operations, etc.) on behalf of the GVM component.

The described techniques relate to improved methods, systems, devices, or apparatuses that support shared memory buffers to submit an interrupt request (IRQ) worklist to a back end virtual machine (VM) (e.g., a PVM component). Generally, the described techniques provide for control or regulation about how often certain events or tasks are communicated between a back end (e.g., a PVM component) to a front end (e.g., a GVM component). For example, the described techniques may provide for dynamic real-time composition of worklists (e.g., in memory shared between a GVM component and a PVM component) to allow a subset of IRQs (e.g., one or more selected IRQs) to be serviced by the PVM component. A device or virtualization system (e.g., a wireless device) may select one or more IO requests from some set of IO requests, and may enter (e.g., write) interrupt request information (e.g., IRQs corresponding to the selected IO requests) as work items into shared memory (e.g., memory shared between a GVM component and a PVM component). The PVM component may thus read the interrupt request information from the shared memory and process the interrupt request information corresponding to the IRQs selected by the GVM component (e.g., the interrupt request information corresponding to the IRQs associated with IO requests that are selected by the GVM component for servicing by the PVM component).

A method of virtualization at a device is described. The method may include selecting, based on an interrupt request, one or more input/output requests of a set of input/output requests and writing, by a guest virtual machine component of the device based on the selected one or more input/output requests, interrupt request information to one or more locations in memory shared by the guest virtual machine component of the device and a physical virtual machine component of the device. The method may further include reading, by the physical virtual machine component of the device, the interrupt request information in the one or more locations from the shared memory and processing, by the physical virtual machine component of the device, the interrupt request information based on reading the interrupt request information in the shared memory.

An apparatus for virtualization at a device is described. The apparatus may include a processor, memory coupled with the processor, and instructions stored in the memory. The instructions may be executable by the processor to cause the apparatus to select, based on an interrupt request, one or more input/output requests of a set of input/output requests and write, by a guest virtual machine component of the device based on the selected one or more input/output requests, interrupt request information to one or more locations in memory shared by the guest virtual machine component of the device and a physical virtual machine component of the device. The instructions may be executable by the processor to further cause the apparatus to read, by the physical virtual machine component of the device, the interrupt request information in the one or more locations from the shared memory and process, by the physical virtual machine component of the device, the interrupt request information based on reading the interrupt request information in the shared memory.

Another apparatus for virtualization at a device is described. The apparatus may include means for selecting, based on an interrupt request, one or more input/output requests of a set of input/output requests and writing, by a guest virtual machine component of the device based on the selected one or more input/output requests, interrupt request information to one or more locations in memory shared by the guest virtual machine component of the device and a physical virtual machine component of the device. The apparatus may further include means for reading, by the physical virtual machine component of the device, the interrupt request information in the one or more locations from the shared memory and processing, by the physical virtual machine component of the device, the interrupt request information based on reading the interrupt request information in the shared memory.

A non-transitory computer-readable medium storing code for virtualization at a device is described. The code may include instructions executable by a processor to select, based on an interrupt request, one or more input/output requests of a set of input/output requests and write, by a guest virtual machine component of the device based on the selected one or more input/output requests, interrupt request information to one or more locations in memory shared by the guest virtual machine component of the device and a physical virtual machine component of the device. The code may include instructions further executable by a processor to read, by the physical virtual machine component of the device, the interrupt request information in the one or more locations from the shared memory and process, by the physical virtual machine component of the device, the interrupt request information based on reading the interrupt request information in the shared memory.

In some examples of the method, apparatuses, and non-transitory computer-readable medium described herein, writing the interrupt request information to the one or more locations in the shared memory may include operations, features, means, or instructions for setting a write flag, writing a total number of work items, writing one or more work items, or any combination thereof to the one or more locations in the shared memory, where the total number of work items indicate a number of the selected one or more input/output requests and the each of the one or more work items corresponds to one of the one or more input/output requests. In some examples of the method, apparatuses, and non-transitory computer-readable medium described herein, reading the interrupt request information in the one or more locations from the shared memory may include operations, features, means, or instructions for setting a read flag, reading the total number of work items, reading each of the one or more work items, or any combination thereof. Some examples of the method, apparatuses, and non-transitory computer-readable medium described herein may further include operations, features, means, or instructions for updating, by the physical virtual machine component of the device, the total number of work items after each of the one or more work items may be read, and clearing the read flag after all of the one or more work items may have been read.

Some examples of the method, apparatuses, and non-transitory computer-readable medium described herein may further include operations, features, means, or instructions for reading, by the guest virtual machine component of the device, a read flag set by the physical virtual machine component of the device, and selecting the one or more locations in the shared memory based on the read flag, where the interrupt request information may be written based on the selected one or more locations in the shared memory. Some examples of the method, apparatuses, and non-transitory computer-readable medium described herein may further include operations, features, means, or instructions for identifying a starting worklist from a last write index, a last read index, or both, where the read flag may be read based on the identified starting worklist. Some examples of the method, apparatuses, and non-transitory computer-readable medium described herein may further include operations, features, means, or instructions for determining that the one or more locations in the shared memory may be available for writing by the guest virtual machine component of the device based on reading the read flag, and setting a write flag based on the determination, where the interrupt request information may be written based on the setting of the write flag.

Some examples of the method, apparatuses, and non-transitory computer-readable medium described herein may further include operations, features, means, or instructions for reading, by the physical virtual machine component of the device, a write flag set by the guest virtual machine component of the device, and selecting the one or more locations in the shared memory based on the write flag, where the interrupt request information may be read based on the selected one or more locations in the shared memory. Some examples of the method, apparatuses, and non-transitory computer-readable medium described herein may further include operations, features, means, or instructions for identifying a starting worklist from a last write index, a last read index, or both, where the write flag may be read based on the identified starting worklist. Some examples of the method, apparatuses, and non-transitory computer-readable medium described herein may further include operations, features, means, or instructions for determining that the one or more locations in the shared memory may be available for reading by the physical virtual machine component of the device based on reading the write flag, and setting a read flag based on the determination, where the interrupt request information may be read based on the setting of the read flag.

In some examples of the method, apparatuses, and non-transitory computer-readable medium described herein, the interrupt request information includes one or more work items that each include a retired information field, a context information field, a target timestamp information field, or any combination thereof. Some examples of the method, apparatuses, and non-transitory computer-readable medium described herein may further include operations, features, means, or instructions for clearing, by the guest virtual machine component of the device, the retired information field of a first work item of the one or more work items based on writing the first work item. Some examples of the method, apparatuses, and non-transitory computer-readable medium described herein may further include operations, features, means, or instructions for setting, by the physical virtual machine component of the device, the retired information field of a first work item of the one or more work items based on reading the first work item.

In some examples of the method, apparatuses, and non-transitory computer-readable medium described herein, the guest virtual machine component of the device includes a front end component of the device and the physical virtual machine component of the device includes a back end component of the device.

In some examples of the method, apparatuses, and non-transitory computer-readable medium described herein, the back end component accesses hardware of the device based on the set of input/output requests. In some examples of the method, apparatuses, and non-transitory computer-readable medium described herein, the forwarding logic of the back end component may be controlled based on the selection of the one or more input/output requests of the set of input/output requests. In some examples of the method, apparatuses, and non-transitory computer-readable medium described herein, the one or more input/output requests may be selected based on a frequency of the interrupt request.

### BRIEF DESCRIPTION OF THE DRAWINGS

FIG. 1 illustrates an example of a system for virtualization that supports shared memory buffers to submit interrupt request (IRQ) worklist to back end virtual machine (VM) in accordance with aspects of the present disclosure.

FIG. 2 illustrates an example of a shared memory diagram that supports shared memory buffers to submit an IRQ worklist to a back end VM in accordance with aspects of the present disclosure.

FIG. 3 illustrates an example of a process flow that supports shared memory buffers to submit an IRQ worklist to a back end VM in accordance with aspects of the present disclosure.

FIGS. 4 and 5 show block diagrams of devices that support shared memory buffers to submit an IRQ worklist to a back end VM in accordance with aspects of the present disclosure.

FIG. 6 shows a block diagram of a virtualization manager that supports shared memory buffers to submit an IRQ worklist to a back end VM in accordance with aspects of the present disclosure.

FIG. 7 shows a diagram of a system including a device that supports shared memory buffers to submit an IRQ worklist to a back end VM in accordance with aspects of the present disclosure.

FIGS. 8 through 11 show flowcharts illustrating methods that support shared memory buffers to submit an IRQ worklist to a back end VM in accordance with aspects of the present disclosure.

### DETAILED DESCRIPTION

In some implementations, virtualization may increase the use of the capacity of hardware while still ensuring that each user enjoys the features of a “complete” computer. Depending on implementation, virtualization may also provide greater security since the virtualization may isolate potentially unstable or unsafe software so that it cannot adversely affect the hardware state or system files required for running the physical (as opposed to virtual) hardware. A VM is an abstraction—a “virtualization”—of an actual physical computer system. In some implementations, virtualization may be employed to perform various computing tasks, such as tasks in the form of a front end (e.g., a guest virtual machine (GVM)) component submitting hardware requests to a back end (e.g., a physical virtual machine (PVM)) component. As such, a front end may generally submit requests, and a back end may execute one or more commands or one or more requests on behalf of the front end.

In para-virtualization a virtualized device driver in the GVM, sometimes referred to as front end, may use a back end driver in the physical/host VM (e.g., PVM) to complete hardware access. In other words, para-virtualization may involve software split into a front end running a GVM and a back end running a PVM. After the front end submits some input/output (IO) request, the front end may expect interrupt request (IRQ) forwarding from the hardware to indicate the completion of the IO request. The cost of sending an IRQ completion request (e.g., a request for IRQ forwarding) from the front end to the back end may be high. Similarly, the IRQ forwarding from the back end to the front end may also be costly (e.g., in terms of processing power and processing latency). Therefore it may be desirable to remove the cost of sending an IRQ completion request from the front end to the back end, and reduce the occurrence of IRQ forwarding from the back end to the front end (e.g., when the IRQ from hardware is in high-frequency).

According to the techniques described herein, a shared memory may be employed (e.g., between the front end and the back end) to allow the front end to influence (e.g., control) the occurrence of the virtual IRQ forwarding from the back end. The shared memory may include flags and lists to allow the front end to directly control the behavior of the back end virtual IRQ forwarding logic without causing the back end to stop its existing processes. For example, the shared memory may be divided into two areas: [1] one or more flags (e.g., a write (WR) flag and a read (RD) flag), and [2] one or more worklist buffers including any work items of front end (e.g., clients) requesting certain virtual IRQs. Thus, the front end may submit multiple IO requests but may only check the completion of some (e.g., based on work items written into the shared memory, by the front end, for back end processing and IRQ forwarding). Also, there may be a varying number of front end components (e.g., varying number of GVMs) submitting IO requests, and each front end component may have its own intended virtual IRQ to wait. These work items (e.g., GVM IO requests associated with a desired IRQ) may be captured in a worklist stored in shared memory for a back end component (e.g., native driver, PVM, hardware, etc.) to process (based on front end decision on which virtual IRQ to include as work items).

Aspects of the disclosure are initially described in the context of a virtualization system. An example shared memory diagram and example process flow implementing aspects of the disclosure are then described. Aspects of the disclosure are further illustrated by and described with reference to apparatus diagrams, system diagrams, and flowcharts that relate to shared memory buffers to submit an IRQ worklist to a back end VM.

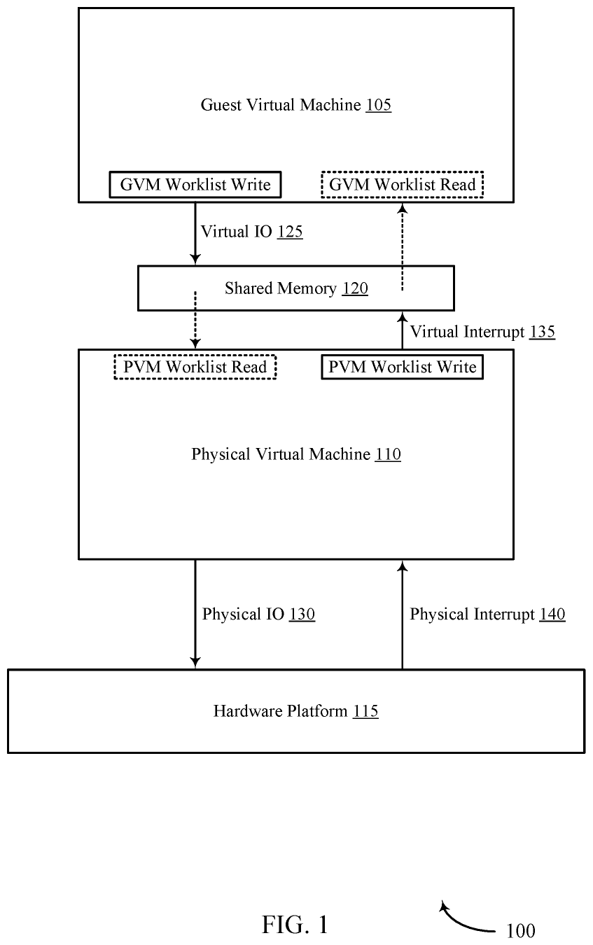

FIG. 1 illustrates an example of a virtualization system 100 that supports shared memory buffers to submit an IRQ worklist to a back end VM (e.g., a PVM 110) in accordance with aspects of the present disclosure. For example, FIG. 1 may illustrate one possible arrangement of a virtualization system 100 that implements virtualization. A GVM 105 (e.g., which may be referred to as a GVM component, a front end, a front end component, a guest, a guest platform, etc.) may be installed on a PVM 110 (e.g., which may be referred to as a PVM component, a back end, a back end component, a host, a host platform, etc.) which may include, interface with, be coupled with, or control system hardware platform 115. In some cases, the PVM 110 may include or refer to one or more layers or co-resident components comprising system-level software, such as an operating system or similar kernel, or a virtual machine monitor or hypervisor (see below), other components or elements, or some combination of these. The system hardware platform 115 may include one or more processors, memory, physical hardware devices including some form of mass storage, etc.

In some cases, at least some if not each GVM 105 may have both virtual system hardware and guest system software. The virtual system hardware may include a virtual central processing unit (CPU), virtual memory, a virtual disk, one or more virtual devices, etc. Note that in some cases a disk—virtual or physical—may also be a “device” but may be considered separately because of the important role of the disk. In some cases, the virtual hardware components of the GVM 105 may be implemented in software to emulate the corresponding physical components. The guest system software may include a guest operating system (OS) and drivers for the various virtual devices. In some examples, virtual system hardware may reside between or be coupled with one or more GVMs (e.g., in cases where virtualization system 100 supports multiple GVMs 105) or between or be coupled with one or more virtual machine monitors (VMMs), etc. This invention may be used regardless of the type of processors (e.g., physical and/or logical) included in a GVM 105 and regardless of the number of processors included in a GVM 105.

Some interface (e.g., PVM 110) may be implemented between the GVM 105 (e.g., between guest software within GVM 105) and at least some of the various hardware components and devices in the underlying hardware platform 115. In some examples, PVM 110 may be referred to as a host, virtualization software, etc. and may include one or more software components and/or layers. In some examples, PVM 110 may include one or more of the software components such as virtual machine monitors (VMMs), hypervisors, or virtualization kernels.

In some examples, these terms do not always delineate between the software layers and components to which they refer. For example, in some cases, a “hypervisor” may be used to describe both a VMM and a kernel together, either as separate but cooperating components or with one or more VMMs incorporated wholly or partially into the kernel itself, however, “hypervisor” may be used instead to mean some variant of a VMM alone, which interfaces with some other software layer(s) or component(s) to support the virtualization. Moreover, in some systems, some virtualization code may be included in at least one “superior” GVM 105 to facilitate the operations of other GVMs 105. Furthermore, specific software support for GVMs 105 may be included in the host OS itself. Unless otherwise indicated, the techniques described herein may be implemented in virtualized computer systems having any type or configuration of virtualization software.

In some examples, the described techniques may be implemented anywhere within the overall structure of the virtualization software, and in some examples, the described techniques may be implemented in systems that provide specific hardware support for virtualization. Different systems may implement virtualization to different degrees—“virtualization” may generally relate to a spectrum of definitions rather than to a bright line, and may reflect a design choice with respect to a trade-off between speed and efficiency on the one hand and isolation and universality on the other hand. For example, “full virtualization” may be used to denote a system in which no software components of any form are included in the guest other than those that would be found in a non-virtualized computer; thus, the guest OS may be a commercially available OS with no components included to specifically support use in a virtualized environment.

In contrast, another concept is that of “para-virtualization.” As the name implies, a “para-virtualized” system may not be “fully” virtualized, but rather the guest may be configured in a way to provide features that facilitate virtualization. Para-virtualization may provide enhancement of virtualization technology such that a guest operating system (a guest OS) may be modified prior to installation inside a VM in order to allow a guest OS within the system to share resources and successfully collaborate (e.g., rather than attempt to emulate an entire hardware environment). With para-virtualization, VMs may be accessed through interfaces that are similar to the underlying hardware. This capacity may reduce overhead and may optimize system performance by supporting the use of VMs that may otherwise be underutilized in full hardware virtualization.

For example, the guest in some para-virtualized systems may be designed to avoid hard-to-virtualize operations and configurations, such as by avoiding one or more privileged instructions, one or more memory address ranges, etc. As another example, some para-virtualized systems may include an interface within the guest that enables explicit calls to other components of the virtualization software. In some examples, para-virtualization may imply that the guest OS (e.g., its kernel) may be designed to support such an interface. In other examples, para-virtualization may more broadly refer to any guest OS with any code that is specifically intended to provide information directly to any other component of the virtualization software. According to this view, loading a module (e.g., a driver) designed to communicate with other virtualization components may render the system para-virtualized (e.g., even if the guest OS is not specifically designed to support a virtualized computer system). Unless otherwise indicated or apparent, the techniques described herein are not restricted to use in systems with any particular “degree” of virtualization and may not to be limited to any particular notion of full or partial (“para-”) virtualization.

In addition to the a distinction between full virtualization and partial (para-) virtualization, multiple arrangements of intermediate system-level software layer(s) may be used—for example, a hosted configuration and a non-hosted configuration. In a hosted virtualized computer system, an existing, general-purpose operating system may form a “host” OS that may be used to perform certain IO operations, alongside and sometimes at the request of the VMM. In a non-hosted configuration, a server operating system may not necessarily be installed (e.g., a server operating system may not necessarily be installed by an administrator, such that the hypervisor may have direct access to hardware resources).

FIG. 1 may illustrate how communication may be completed in a virtualized computer system (e.g., in a virtualization system 100). As described herein, virtualization techniques may involve software split into a front end running a GVM and a back end running a PVM (e.g., where the front end may submit requests and the back end may execute on behalf of the front end). As such, a front end may generally refer to some combination of components and/or software for running a GVM 105, and a back end may generally refer to some combination of components and/or software for running a PVM 110 (e.g., and in some cases the back end may include, refer to, or control hardware platform 115). In some examples, when the GVM 105 (e.g., the guest OS) requests a virtual IO 125 on a virtual system hardware, the PVM 110 may generate a physical IO 130 (e.g., that corresponds to the virtual IO 125 request) to the actual hardware platform 115 (e.g., which may back up the virtual system hardware). Once the physical IO 130 is completed, the hardware platform 115 may generate a physical (hardware) IRQ (e.g., physical interrupt 140) to inform the PVM 110 of the completion of the physical IO 130. In response, the PVM 110 may generate a virtual interrupt 135 to GVM 105 (e.g., to the guest OS) to inform the GVM 105 of completion of the IO request.

According to the techniques described herein, a shared memory 120 may be employed between the front end (e.g., GVM 105) and the back end (e.g., PVM 110) to allow the front end to control the occurrence of the virtual IRQ forwarding (e.g., of the virtual interrupts 135) from the back end. For example, the shared memory 120 may include flags and lists to allow the GVM 105 to directly control the behavior of the PVM 110 virtual interrupt 135 forwarding logic and/or the hardware platform 115 physical interrupt 140 forwarding logic, without causing the PVM 110 and/or the hardware platform 115 to stop its existing processes. For example, the shared memory 120 may be divided into two areas: [1] two flags (e.g., a WR flag and a RD flag) and [2] two worklist buffers including any work items of GVMs 105 (e.g., clients) requesting virtual interrupts 135. Thus, the GVM 105 may submit numerous IO requests (e.g., virtual IOs 125) but may only check the completion of some based on work items written into the shared memory 120 for PVM 110/hardware platform 115 processing and IRQ forwarding (e.g., forwarding of physical interrupts 140 and/or virtual interrupts 135). Also, in some cases, there may be a varying number of GVMs 105 submitting IO requests (e.g., virtual IOs 125), and each GVM 105 may have its own intended virtual interrupt 135 to wait. These work items (e.g., GVM 105 virtual IOs 125 associated with a desired virtual interrupt 135) may be captured in a worklist stored in shared memory 120 for PVM 110 (e.g., back end, native driver, hardware, etc.) to process (based on GVM 105 decision of which virtual IOs 125 or which virtual interrupts 135 to include as work items in the shared memory 120).

As such, GVM 105 (e.g., or the virtualization system 100 as a whole) may select one or more IO requests (e.g., virtual IOs 125) from some set of IO requests. The GVM 105 may then write interrupt request information (e.g., work items) to one or more locations (e.g., to one or more work item locations in a worklist available for GVM 105 writing) in shared memory 120. The interrupt request information (e.g., work items) may refer to information indicating the selected one or more IO requests (e.g., the selected one or more virtual IOs 125) and/or information indicating one or more IRQs (e.g., one or more virtual interrupts 135) corresponding to the selected one or more IO requests. As such, PVM 110 may read the interrupt request information from shared memory 120 (e.g., when the worklist including the interrupt request information is available for reading by the PVM 110, as described herein), may process the interrupt request information, and hardware platform 115 and PVM 110 may forward physical interrupts 140 and virtual interrupts 135, respectively, according to what is requested or configured via the work items (interrupt request information) in shared memory 120.

The techniques described herein may thus control or reduce the cost of sending an IRQ completion request (e.g., a request for IRQ forwarding) from the front end (e.g., from GVM 105) to the back end (e.g., to PVM 110 and/or hardware platform 115). Similarly, the cost of IRQ forwarding (e.g., forwarding of physical interrupts 140 and/or virtual interrupts 135) from the back end to the front end may also be reduced (e.g., in terms of reduced processing power and reduced processing latency). For example, some systems may use remote procedure call (RPC) core forwards (e.g., such as a draw frame request) from front end to back end. With RPC core, requesting an IRQ request in user mode driver may go from front end to backend, and the back end may provide a return value. Such a full round trip may be costly for all IRQs, and the described techniques may be implemented to reduce processing power and processing latency in such systems via shared memory buffers to submit an IRQ worklist to a back end VM.

In some cases, virtualization system 100 (e.g., GVM 105) configuration of IRQ forwarding logic may depend on the hardware platform 115 and the running use case. For example, for some hardware use cases there may be low-frequency IRQ (e.g., such as display hardware, such as under 60 frames per second (fps)). In such low-frequency IRQ examples, the processing power and processing latency costs of IRQ forwarding from the back end to the front end may be less relative to high-frequency IRQ examples. For example, for other hardware use cases (e.g., graphics, offscreen video, audio encoding/decoding, etc.) may be associated with high-frequency IRQ (e.g., 1000 fps). In such high-frequency IRQ examples, so many IRQs (e.g., 2000-3000 IRQs) may occur, and in some systems all occurrences may be forwarded from the back end to the front end (e.g., from the PVM 110 to the GVM 105). Such may result in substantial overhead from the PVM 110 to the GVM 105 and, in some cases, the GVM 105 may not want or may not need all of such IRQs forwarded.

As such, in some cases, the described techniques may be implemented to control IRQ forwarding logic and reduce processing power and processing latency depending on the frequency of IRQ forwarding for various use cases. For example, in some cases, GVM 105 may be more selective in IRQ forwarding control (e.g., in what work items are written to shared memory 120) in cases of high-frequency IRQ forwarding, as the processing power and processing latency savings may be more significant in such cases. As an example, if hardware platform 115 is operating in some mode where a high frequency of IRQs would otherwise be generated, the described techniques may be implemented to reduce the frequency of IRQ forwarding (e.g., based on interrupt request information written to shared memory 120 by GVM 105).

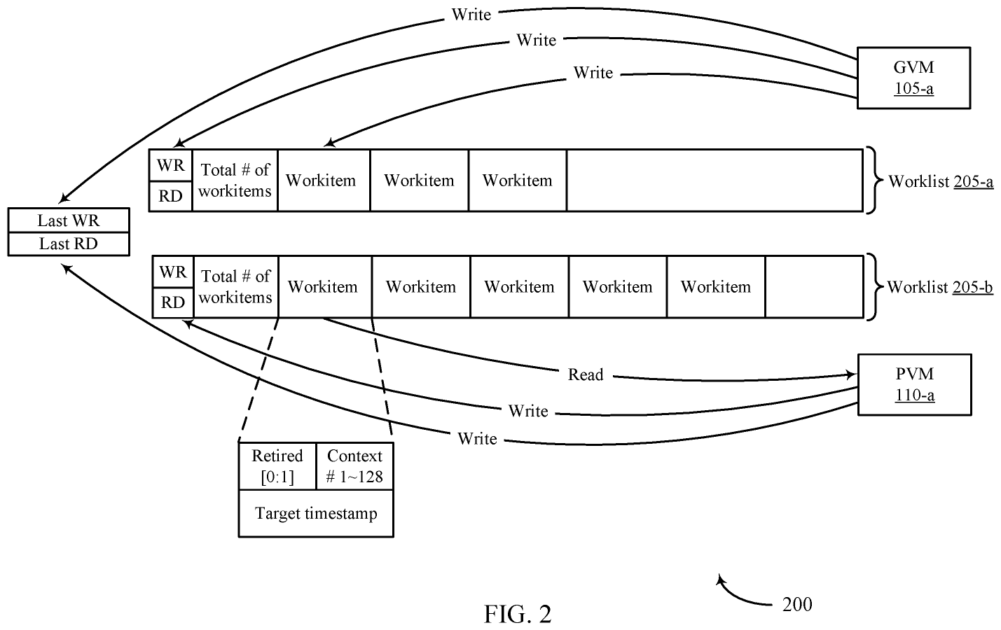

Further, if there is a request to be forwarded (e.g., if the GVM 105 requests IRQ forwarding for some IO request), the described techniques may be implemented to simplify and speed up the forwarding using half-duplex (e.g., via two worklists of the shared memory, as further described with reference to FIG. 2). For example, when one IRQ (e.g., a virtual interrupt 135) arrives at the GVM 105, while the GVM 105 is reading the IRQ, a second IRQ may be unnecessary (e.g., consume unnecessary overhead) because while the GVM 105 is processing the first IRQ, the GVM 105 should continue and read IRQ status information from the PVM 110 while the GVM 105 writes to shared memory 120.

FIG. 2 illustrates an example of a shared memory diagram 200 that supports shared memory buffers to submit an IRQ worklist to a back end VM in accordance with aspects of the present disclosure. In some examples, shared memory diagram 200 may implement aspects of virtualization system 100.

As described herein, an IO request (e.g., a virtual IO 125) may be made from a front end (e.g., GVM 105-a) to a back end (e.g., PVM 110-a) to submit to hardware for processing. An IRQ request may be made after an IO request is successfully submitted into hardware from the front end/GVM 105-a to the back end/PVM 110-a (e.g., similar to how a driver submit IO requests to hardware, then hardware returns IRQ after it completes). In para-virtualization these two steps may become RPC calls. IRQ identification may be an IRQ number in GVM 105-a, similar to normal IRQ number in native OS, but the GVM 105-a IRQ may be virtual and injected from PVM 110-a. There may be two kinds of solutions, the front end running in user mode may allow multiple instances of it, usually choose RPC calls from front end to back end. Each RPC call may result in GVM goes out to PVM, and PVM replies to GVM.

The described techniques may support dynamic control of virtual IRQ forwarding logic (e.g., and remove the need to send the IRQ request from GVM 105-a to PVM 110-a), using shared memory to directly write out work items to a worklist 205. When existing solutions may provide “event” delivery method from back end to front end (e.g., similar to the described virtual IRQ forwarding), there may be no control/regulation on how often these “events” are going from the back end to the front end. The described techniques may thus provide for dynamic real-time composition of worklists 205 to allow only requested IRQ to be forwarded to GVM 105-a from PVM 110-a. The techniques described herein may be described with reference to a double buffer (e.g., or two worklist 205) shared memory for a pair of front end (e.g., GVM 105-a) and back end (e.g., PVM 110-a) running for one or more IRQ. Aspects of the described techniques may be applicable to concurrent running of multiple front ends and back ends by analogy (e.g., by employing triple buffer or other multiple buffer methods), without departing from the scope of the present disclosure.

Aspects of the described techniques provide for defined flags and lists in shared memory (e.g., such as a shared memory illustrated by shared memory diagram 200) to allow the front end to directly control the behavior of the PVM 110-a virtual IRQ forwarding logic without causing the PVM 110-a stop its existing processing (e.g., and thus allow the PVM 110-a to optimize efficiency). The virtual IRQ (e.g., a virtual interrupt 135) to the front end may only be generated and/or forwarded when the front end client (e.g., when GVM 105-a) is waiting for it (e.g., when the GVM 105-a requests the virtual IRQ in the form of writing a corresponding work item in shared memory). The front end may submit a large amount of the IO requests (e.g., virtual IOs 125) but the front end may only want to check the completion of the last one or a particular one. Also there may be a few front ends submitting IO requests and each one may have its own intended virtual IRQ to wait, so the virtual IRQ forwarding control of one or more front ends may be dynamic. Such dynamic control may be captured as a list (e.g., a worklist 205) to be stored in shared memory for a back end to process to decide how many virtual IRQ to forward. That is, GVM 105-a may dynamically control virtual IRQ forwarding via writing work items to worklists 205 in shared memory, such that PVM 110-a may process the worklists 205 to decide how many, and which, virtual IRQs to forward to the GVM 105-a.

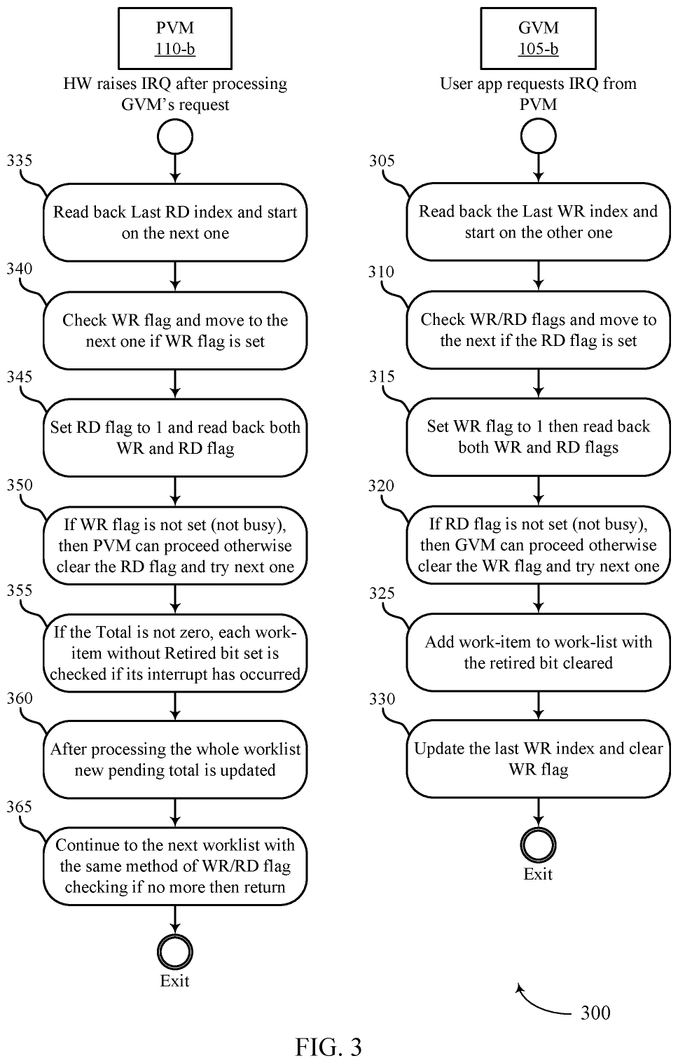

Inside shared memory, two worklists 205 are created to allow each side, PVM 110-a and GVM 105-a, to be able to access at least one buffer (e.g., at least one worklist 205) at any given time. Shared memory diagram 200 may illustrate an example data structure of the double buffered worklists 205 for shared memory (e.g., and the work flow of GVM 105-a and PVM 110-a using the double buffered worklists 205-a and 205-b is described in more detail herein, for example, with reference to FIG. 3).

A worklist 205 may stores one or more work items, and each work item may include or refer to a request from the GVM 105-a (e.g., a client/app) that requests or requires IRQ notification. Generally, the details of the work item may be left for each different use case/methodology to define. For example, one usage may be that hardware uses its interrupt sequence number to the client when its work-order has been submitted into the hardware for processing. Upon completion of this work-order, the interrupt number may be reported by the hardware to the software (driver). Based on this sequence number, the software may identify or determine that its work has been completed. In a graphics processing unit (GPU) processing case, the interrupt sequence number may be referred to as a GPU timestamp, or an open computing language (OpenCL) event object associated with the command queue. In this example, it may use GVM 105-a client/app's index number as context number and the interrupt sequence number is “Target timestamp”.

The Last WR and Last RD may be used by one side (e.g., by either GVM 105-a or PVM 110-a) at a time. The Last WR and Last RD may serve as the starting point when new access to either worklist 205-a or worklist 205-b happens. For example, new access by either GVM 105-a or PVM 110-a to a worklist 205 may start at a worklist 205 other one than worklist 205 indicated by the Last WR/RD, since that should be the newly updated worklist 205 from the remote side. For example, Last WR may be updated and read on the front end/GVM 105-a side to indicate which worklist 205 was updated last. When the front end/GVM 105-a starts again upon receiving a “wait-for-interrupt” call from clients/apps, the front end/GVM 105-a may start on the next worklist 205 other than the Last WR based on the assumption the back end/PVM 110-a may be in the process of reading the worklist 205 to decide where or not IRQ forwarding is needed. Similarly, the Last RD may be used by the back end/PVM 110-a.

Each worklist 205 may also have its WR and RD flags, last WR and last RD indices, total number of work items in this worklist 205. The WR and RD flags fit into one integer to guarantee one atomic read fetching both flags at the same time to determine this worklist 205 for GVM 105-a to write to or PVM 110-a to read. As an example, RD flag and WR flag may be one 32 bit integer with high 16 bit as RD flag and low 16 as WR flag. There may be little chance both sides try to read or write to the same worklist 205, as the simple hand-shake may allow the first one (e.g., either GVM 105-a or PVM 110-a) to read back that the other side is not busy on the particular worklist 205, such that the first one may then get the access to the particular worklist 205 at that time. If either GVM 105-a or PVM 110-a reads back both WR and RD are set (being 1 s), then it will release/clear its flags and try to access the next worklist 205. The different instructions/execution speed may give one side (e.g., either GVM 105-a or PVM 110-a) a little faster to secure the access (e.g., even if both start attempting to access a worklist 205 at the same time).

For example, a front end (e.g., GVM 105-a) may maintain a WR index and a back end (e.g., PVM 110-a) may maintain a RD index. The WR index and the RD index may store information indicating the last completed worklist 205. The GVM 105-a may write to a WR index when the GVM 105-a is finished with a worklist 205, and may read the WR index to see which worklist 205 was last used. PVM 110-a may be still reading from a worklist 205 last written to by GVM 105-a. Based on the usage of the Last WR/RD and worklist local WR RD, the two sides (e.g., GVM 105-a and PVM 110-a) may read and write to different worklists 205 at the same time. For example, upon identification of an interrupt request, GVM 105-a may read such information to determine which worklist 205 to work in (e.g., based on a status of whether a worklist 205 is busy). The GVM 105-a may then write to the status register to indicate the GVM 105-a is writing to and occupying the worklist 205, such that the PVM 110-a doesn't use the worklist 205 while it is occupied by the GVM 105-a.

The Total # of work items may store the current total number of work items inside the worklist 205. The Total # of work items may first be written out by the GVM 105-a to indicate the total work items in the worklist 205. When PVM 110-a starts to process a worklist 205, if the work item has been completed by the hardware, PVM 110-a may clear the retire bit and decrease the Total # of work items counter in the worklist 205. When Total # of work items becomes zero, the PVM 110-a may skip processing the worklist 205 to save the time to move to the next worklist 205.

Inside work item the “Context #” and “Target timestamp” may be implementation specific. It could be expanded to reflect the needs between PVM 110-a and GVM 105-a to notify each other on how to describe the IRQ forward logic control. The “Retired” may be initialized by GVM 105-a (cleared), then set by PVM 110-a (set to 1) to avoid the PVM 110-a to re-examine the work item when it examines the same worklist again. In some examples, a work item may be read by GVM 105-a and written by PVM 110-a except Retired bit may be written by PVM 110-a and written by GVM 105-a afterwards). A Retired bit may be part of the work item initially written to a worklist 205 when GVM 105-a/front end client/app requests IRQ notification. The Retired bit may be cleared to zero to start with by GVM 105-a/front end. Later on when PVM 110-a/back end processes it, PVM 110-a/back end may set the Retired bit to 1 after IRQ forwarding happened to prevent processing the same work item when a new IRQ occurred. So PVM 110-a/back end may read, then write, then read on this “Retired” bit, and the GVM 105-a/front end may write/initialize the Retired bit.

All the processing may begin with the GVM 105-a to compose the worklist 205-a for PVM 110-a to process when IRQ occurs. The GVM 105-a may maintains its own local. When new interrupt forwarding request arrives, GVM 105-a may populate all existing client's requests to a worklist 205 as work items (e.g., where the worklist 205 may be selected based on Last WR/RD and worklist local WR RD as described herein).

FIG. 3 illustrates an example of a process flow 300 that supports shared memory buffers to submit an IRQ worklist to a back end VM in accordance with aspects of the present disclosure. In some examples, process flow 300 may implement aspects of virtualization system 100 and shared memory diagram 200. For example, process flow 300 may illustrate operations performed by a GVM 105-b and a PVM 110-b (e.g., using shared memory 120). In the following description of the process flow 300, the operations performed by GVM 105-b and a PVM 110-b may be performed in different orders or at different times. Certain operations may also be left out of the process flow 300, or other operations may be added to the process flow 300. It is to be understood that while GVM 105-b and a PVM 110-b are shown performing a number of the operations of process flow 300, any front end configuration and back end configuration, respectively, may perform the operations shown.

All the processing may begin with the GVM 105-b to compose the worklist for PVM 110-b to process when IRQ occurs. The GVM 105-b may maintain its own local. When new interrupt forwarding request arrives, GVM 105-b may populate all existing client's requests to worklist as work items. One or more aspects of 305-330 and 335-365 may happen or may be performed concurrently. The protocol described herein is to avoid hard-synchronization between the two sides (e.g., between the GVM 105-b and the PVM 110-b), so that each of them may run as close to full capacity as possible.

At 305, after client/app issues requests to the driver, when they request IRQ forwarding to wake them up when hardware completes the workorder, the driver running in GVM 105-b may read back the Last WR to determine which new worklist to update with the newly requested work item.

At 310, GVM 105-b may read back the WR and RD flags to see if this worklist (e.g., the current worklist or the initial worklist the GVM 105-b starts with) is already busy. If PVM 110-b is accessing the worklist, the RD flag may be set, so GVM 105-b may avoid this worklist by moving on to the next worklist, the original “Last WR”.

At 315 and 320, if RD flag is not set, GVM 105-b driver may set the WR flag to indicate to the PVM 110-b that the present worklist is busy for “write” by the GVM 105-b. In some examples, the GVM 105-b driver may use a mutual exclusion object (mutex) to guarantee the exclusiveness at driver level. Then the driver may read back both “WR” and “RD” flags to determine if the same worklist is being accessed by PVM 110-b for “read” at the same time. If “RD” flag is set, then GVM 105-b driver may clear the “WR” flag, and try a next worklist (e.g., and set the WR flag to 1 and read back both WR and RD flags). If “RD” flag is not set, then GVM 105-b driver can safely proceed.

At 325, GVM 105-b driver may populate all the existing clients/apps requesting IRQ as work items into the worklist. GVM 105-b may clear the Retired bit in the work item, and set the Total # of work items in the worklist accordingly.

At 330, after GVM 105-b is done with the worklist (e.g., after GVM 105-b is done writing work items corresponding to requested IRQs), GVM 105-b may update the Last WR and clear the WR flag, then return.

For PVM 110-b, the work flow may begin when native driver is servicing the interrupt. At 335, PVM 110-b driver may read back Last RD index and start on the next (e.g., other) worklist (e.g., the worklist other than the worklist indicated as last read).

At 340, PVM 110-b driver may check the WR flag of the “next” worklist. The PVM 110-b may proceed if the WR flag is not set. Otherwise, the PVM 110-b may move back to the “Last RD” to avoid contention to the same worklist.

At 345 and 350, after PVM 110-b finds the available worklist, PVM 110-b may sets RD flag to 1 and read back both WR and RD flags to confirm the WR flag is not set. If there is no contention, PVM 110-b may proceed. Otherwise, PVM 110-b may clear the RD flag and move onto the next worklist.

At 355, if the Total # of work items in the current worklist is not zero, PVM 110-b may read (e.g., and process) all the work items. If the work item is “Retired”, the retired work item may be skipped. If a work item is not retired, the PVM 110-b driver may determine if the occurred IRQ is for this work item. Such may be determined based on implementation specific knowledge such as GPU's frame timestamp. If the work item is retired, the “Retired” bit may be cleared. PVM 110-b driver may move onto the next work item until every work item in the worklist is processed.

At 360, after every non-Retired work item has been processed, the Total # of work items may be updated with the new remaining work items. Such may allow for the same worklist to be processed faster when a new interrupt occurs and GVM 105-b hasn't provided a new worklist.

At 365, PVM 110-b may continue to the next worklist after clearing the RD flag in the current worklist. Such may allow for faster processing of the newly provided worklist from GVM 105-b without waiting for a new round of IRQ. After all is done, the Last RD index may be updated, then return. As used herein, a current or present worklist may refer to a worklist currently being examined or inspected (e.g., for reading or writing) by the PVM or GVM. A next or other worklist may refer to the other worklist in the double buffer shared memory other than the worklist currently being examined or inspected (e.g., a next or other worklist may be available, and transitioned to, in cases where the current or present worklist is occupied by the other side).

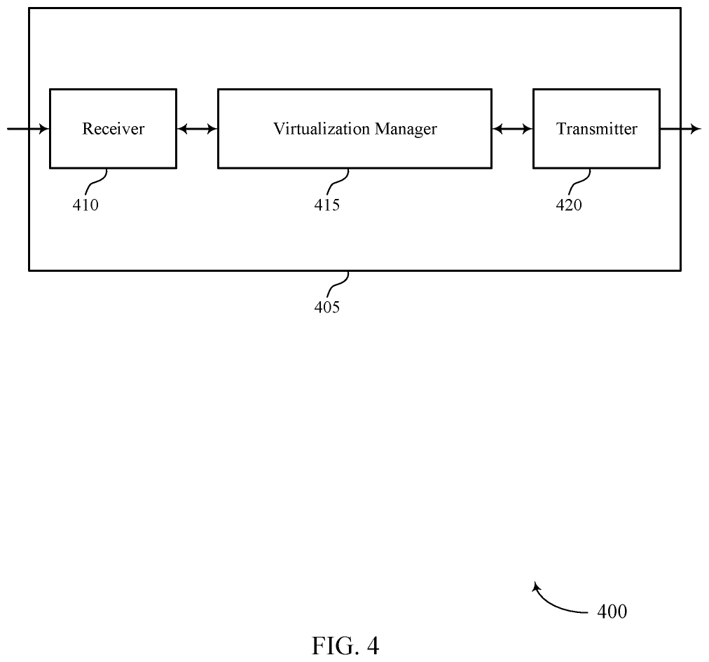

FIG. 4 shows a block diagram 400 of a device 405 that supports shared memory buffers to submit an IRQ worklist to a back end VM in accordance with aspects of the present disclosure. The device 405 may be an example of aspects of a device as described herein. The device 405 may include a receiver 410, a virtualization manager 415, and a transmitter 420. The device 405 may also include a processor. Each of these components may be in communication with one another (e.g., via one or more buses).

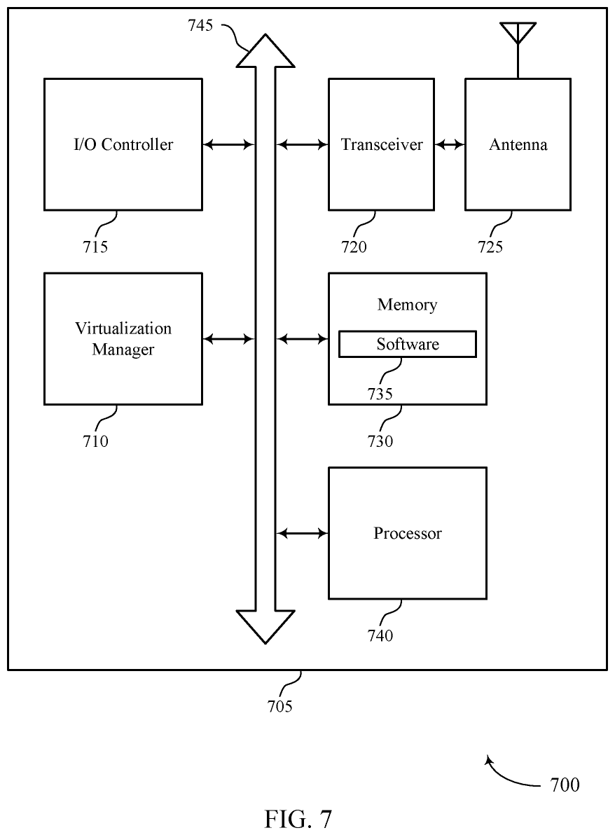

The receiver 410 may receive information such as packets, user data, or control information associated with various information channels (e.g., control channels, data channels, and information related to shared memory buffers to submit an IRQ worklist to a back end VM, etc.). Information may be passed on to other components of the device 405. The receiver 410 may be an example of aspects of the transceiver 720 described with reference to FIG. 7. The receiver 410 may utilize a single antenna or a set of antennas.

The virtualization manager 415 may select, based on an interrupt request, one or more input/output requests of a set of input/output requests, write, by a guest virtual machine component of the device based on the selected one or more input/output requests, interrupt request information to one or more locations in memory shared by the guest virtual machine component of the device and a physical virtual machine component of the device, read, by the physical virtual machine component of the device, the interrupt request information in the one or more locations from the shared memory, and process, by the physical virtual machine component of the device, the interrupt request information based on reading the interrupt request information in the shared memory. The virtualization manager 415 may be an example of aspects of the virtualization manager 710 described herein.

The virtualization manager 415, or its sub-components, may be implemented in hardware, code (e.g., software or firmware) executed by a processor, or any combination thereof. If implemented in code executed by a processor, the functions of the virtualization manager 415, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The virtualization manager 415, or its sub-components, may be physically located at various positions, including being distributed such that portions of functions are implemented at different physical locations by one or more physical components. In some examples, the virtualization manager 415, or its sub-components, may be a separate and distinct component in accordance with various aspects of the present disclosure. In some examples, the virtualization manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

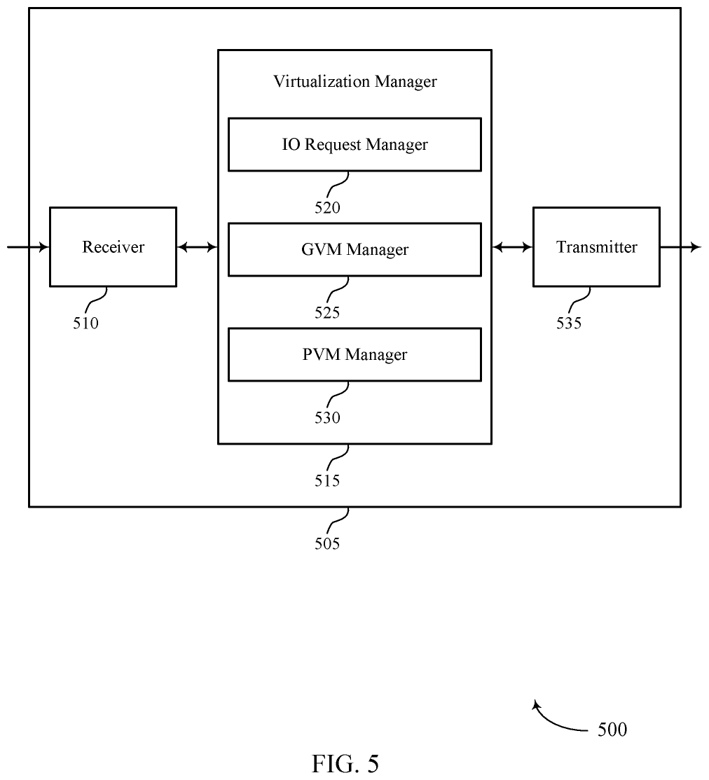

FIG. 5 shows a block diagram 500 of a device 505 that supports shared memory buffers to submit an IRQ worklist to a back end VM in accordance with aspects of the present disclosure. The device 505 may be an example of aspects of a device 405 or a device as described herein. The device 505 may include a receiver 510, a virtualization manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to shared memory buffers to submit an IRQ worklist to a back end VM, etc.). Information may be passed on to other components of the device 505. The receiver 510 may be an example of aspects of the transceiver 720 described with reference to FIG. 7. The receiver 510 may utilize a single antenna or a set of antennas.

The virtualization manager 515 may be an example of aspects of the virtualization manager 415 as described herein. The virtualization manager 515 may include an IO request manager 520, a GVM manager 525, and a PVM manager 530. The virtualization manager 515 may be an example of aspects of the virtualization manager 710 described herein.

The IO request manager 520 may select, based on an interrupt request, one or more input/output requests of a set of input/output requests.

The GVM manager 525 may write, by a guest virtual machine component of the device based on the selected one or more input/output requests, interrupt request information to one or more locations in memory shared by the guest virtual machine component of the device and a physical virtual machine component of the device.

The PVM manager 530 may read, by the physical virtual machine component of the device, the interrupt request information in the one or more locations from the shared memory and process, by the physical virtual machine component of the device, the interrupt request information based on reading the interrupt request information in the shared memory.

The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

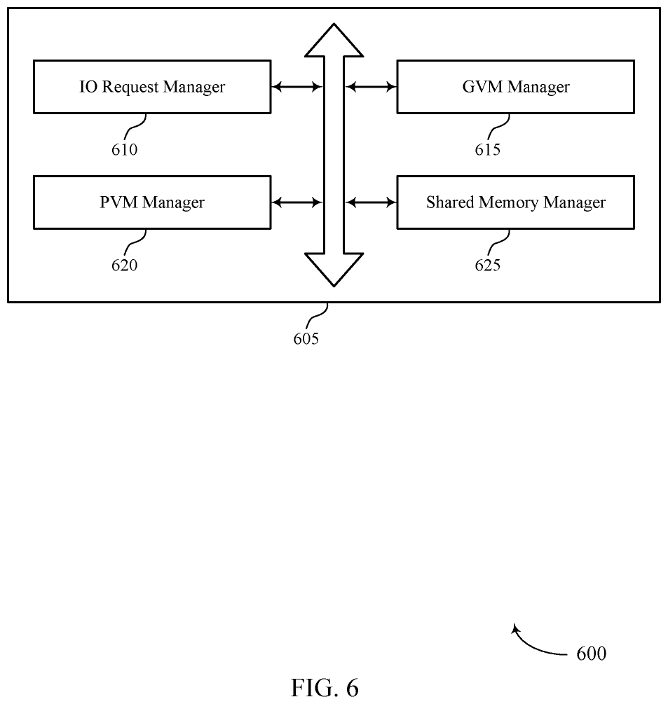

FIG. 6 shows a block diagram 600 of a virtualization manager 605 that supports shared memory buffers to submit an IRQ worklist to a back end VM in accordance with aspects of the present disclosure. The virtualization manager 605 may be an example of aspects of a virtualization manager 415, a virtualization manager 515, or a virtualization manager 710 described herein. The virtualization manager 605 may include an IO request manager 610, a GVM manager 615, a PVM manager 620, and a shared memory manager 625. Each of these modules may communicate, directly or indirectly, with one another (e.g., via one or more buses).

The IO request manager 610 may select, based on an interrupt request, one or more input/output requests of a set of input/output requests. The GVM manager 615 may write, by a guest virtual machine component of the device based on the selected one or more input/output requests, interrupt request information to one or more locations in memory shared by the guest virtual machine component of the device and a physical virtual machine component of the device. In some examples, the GVM manager 615 may set a write flag, writing a total number of work items, writing one or more work items, or any combination thereof to the one or more locations in the shared memory, where the total number of work items indicate a number of the selected one or more input/output requests and the each of the one or more work items corresponds to one of the one or more input/output requests. In some examples, the GVM manager 615 may read, by the guest virtual machine component of the device, a read flag set by the physical virtual machine component of the device. In some examples, the GVM manager 615 may select the one or more locations in the shared memory based on the read flag, where the interrupt request information is written based on the selected one or more locations in the shared memory. In some examples, the GVM manager 615 may clear, by the guest virtual machine component of the device, the retired information field of a first work item of the one or more work items based on writing the first work item.

In some cases, the interrupt request information includes one or more work items that each include a retired information field, a context information field, a target timestamp information field, or any combination thereof. In some cases, the guest virtual machine component of the device includes a front end component of the device and the physical virtual machine component of the device includes a back end component of the device. In some cases, the back end component accesses hardware of the device based on the set of input/output requests. In some cases, the forwarding logic of the back end component is controlled based on the selection of the one or more input/output requests of the set of input/output requests. In some cases, the one or more input/output requests are selected based on a frequency of the interrupt request.

The PVM manager 620 may read, by the physical virtual machine component of the device, the interrupt request information in the one or more locations from the shared memory. In some examples, the PVM manager 620 may process, by the physical virtual machine component of the device, the interrupt request information based on reading the interrupt request information in the shared memory. In some examples, the PVM manager 620 may set a read flag, reading the total number of work items, reading each of the one or more work items, or any combination thereof. In some examples, the PVM manager 620 may read, by the physical virtual machine component of the device, a write flag set by the guest virtual machine component of the device. In some examples, the PVM manager 620 may set, by the physical virtual machine component of the device, the retired information field of a first work item of the one or more work items based on reading the first work item.

The shared memory manager 625 may update, by the physical virtual machine component of the device, the total number of work items after each of the one or more work items are read. In some examples, the shared memory manager 625 may clear the read flag after all of the one or more work items have been read. In some examples, the shared memory manager 625 may identify a starting worklist from a last write index, a last read index, or both, where the read flag is read based on the identified starting worklist. In some examples, the shared memory manager 625 may determine that the one or more locations in the shared memory are available for writing by the guest virtual machine component of the device based on reading the read flag. In some examples, the shared memory manager 625 may set a write flag based on the determination, where the interrupt request information is written based on the setting of the write flag.

In some examples, the shared memory manager 625 may select the one or more locations in the shared memory based on the write flag, where the interrupt request information is read based on the selected one or more locations in the shared memory. In some examples, the shared memory manager 625 may identify a starting worklist from a last write index, a last read index, or both, where the write flag is read based on the identified starting worklist. In some examples, the shared memory manager 625 may determine that the one or more locations in the shared memory are available for reading by the physical virtual machine component of the device based on reading the write flag. In some examples, the shared memory manager 625 may set a read flag based on the determination, where the interrupt request information is read based on the setting of the read flag.

FIG. 7 shows a diagram of a system 700 including a device 705 that supports shared memory buffers to submit an IRQ worklist to a back end VM in accordance with aspects of the present disclosure. The device 705 may be an example of or include the components of device 405, device 505, or a device as described herein. The device 705 may include components for bi-directional voice and data communications including components for transmitting and receiving communications, including a virtualization manager 710, an I/O controller 715, a transceiver 720, an antenna 725, memory 730, and a processor 740. These components may be in electronic communication via one or more buses (e.g., bus 745).

The virtualization manager 710 may select, based on an interrupt request, one or more input/output requests of a set of input/output requests, write, by a guest virtual machine component of the device based on the selected one or more input/output requests, interrupt request information to one or more locations in memory shared by the guest virtual machine component of the device and a physical virtual machine component of the device, read, by the physical virtual machine component of the device, the interrupt request information in the one or more locations from the shared memory, and process, by the physical virtual machine component of the device, the interrupt request information based on reading the interrupt request information in the shared memory.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the device may include a single antenna 725. However, in some cases the device may have more than one antenna 725, which may be capable of concurrently transmitting or receiving multiple wireless transmissions.

The memory 730 may include random access memory (RAM) and read-only memory (ROM). The memory 730 may store computer-readable, computer-executable code or software 735 including instructions that, when executed, cause the processor to perform various functions described herein. In some cases, the memory 730 may contain, among other things, a basic input output system (BIOS) which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting shared memory buffers to submit an IRQ worklist to a back end VM).

The software 735 may include instructions to implement aspects of the present disclosure, including instructions to support virtualization. The software 735 may be stored in a non-transitory computer-readable medium such as system memory or other type of memory. In some cases, the software 735 may not be directly executable by the processor 740 but may cause a computer (e.g., when compiled and executed) to perform functions described herein.

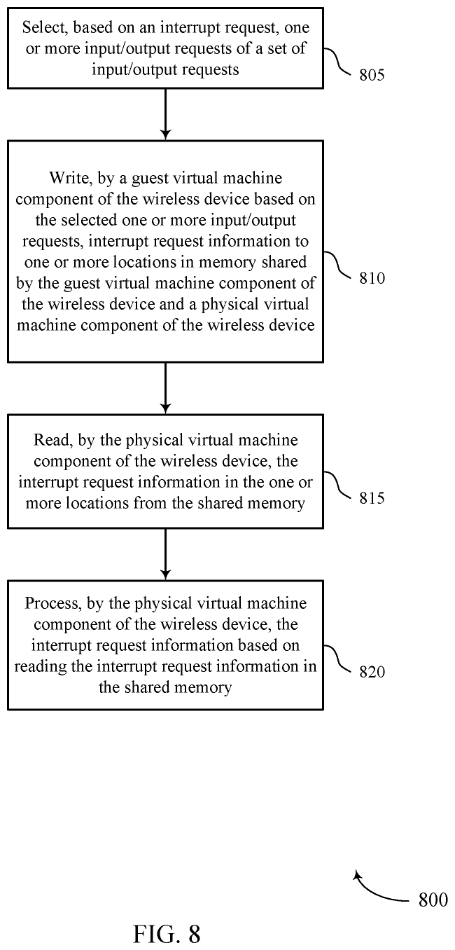

FIG. 8 shows a flowchart illustrating a method 800 that supports shared memory buffers to submit an IRQ worklist to a back end VM in accordance with aspects of the present disclosure. The operations of method 800 may be implemented by a device or its components as described herein. For example, the operations of method 800 may be performed by a virtualization manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may select, based on an interrupt request, one or more input/output requests of a set of input/output requests. The operations of 805 may be performed according to the methods described herein. In some examples, aspects of the operations of 805 may be performed by an IO request manager as described with reference to FIGS. 4 through 7.

At 810, the device may write (e.g., by a guest virtual machine component of the device), based on the selected one or more input/output requests, interrupt request information to one or more locations in memory shared by the guest virtual machine component of the device and a physical virtual machine component of the device. The operations of 810 may be performed according to the methods described herein. In some examples, aspects of the operations of 810 may be performed by a GVM manager as described with reference to FIGS. 4 through 7.

At 815, the device may read, by the physical virtual machine component of the device, the interrupt request information in the one or more locations from the shared memory. The operations of 815 may be performed according to the methods described herein. In some examples, aspects of the operations of 815 may be performed by a PVM manager as described with reference to FIGS. 4 through 7.

At 820, the device may process, by the physical virtual machine component of the device, the interrupt request information based on reading the interrupt request information in the shared memory. The operations of 820 may be performed according to the methods described herein. In some examples, aspects of the operations of 820 may be performed by a PVM manager as described with reference to FIGS. 4 through 7.

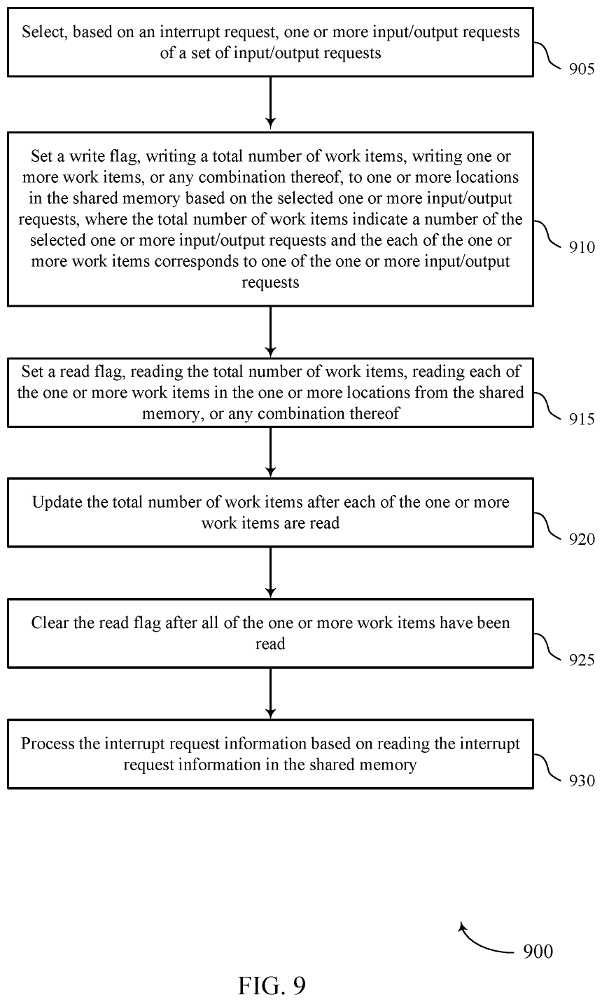

FIG. 9 shows a flowchart illustrating a method 900 that supports shared memory buffers to submit an IRQ worklist to a back end VM in accordance with aspects of the present disclosure. The operations of method 900 may be implemented by a device or its components as described herein. In some cases, the device may refer to a wireless device. For example, the operations of method 900 may be performed by a virtualization manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may select, based on an interrupt request, one or more input/output requests of a set of input/output requests. The operations of 905 may be performed according to the methods described herein. In some examples, aspects of the operations of 905 may be performed by an IO request manager as described with reference to FIGS. 4 through 7.

At 910, the device may set a write flag, writing a total number of work items, writing one or more work items, or any combination thereof to one or more locations in shared memory based on the selected one or more input/output requests, where the total number of work items indicate a number of the selected one or more input/output requests and the each of the one or more work items corresponds to one of the one or more input/output requests. The operations of 910 may be performed according to the methods described herein. In some examples, aspects of the operations of 910 may be performed by a GVM manager as described with reference to FIGS. 4 through 7.

At 915, the device may set a read flag, reading the total number of work items, reading each of the one or more work items, or any combination thereof. The operations of 915 may be performed according to the methods described herein. In some examples, aspects of the operations of 915 may be performed by a PVM manager as described with reference to FIGS. 4 through 7.

At 920, the device may update (e.g., by the physical virtual machine component of the device) the total number of work items after each of the one or more work items are read. The operations of 920 may be performed according to the methods described herein. In some examples, aspects of the operations of 920 may be performed by a shared memory manager as described with reference to FIGS. 4 through 7.

At 925, the device may clear the read flag after all of the one or more work items have been read. The operations of 925 may be performed according to the methods described herein. In some examples, aspects of the operations of 925 may be performed by a shared memory manager as described with reference to FIGS. 4 through 7.

At 930, the device may process (e.g., by the physical virtual machine component of the device) the interrupt request information (e.g., the one or more work items) based on reading the interrupt request information (e.g., the one or more work items) in the shared memory. The operations of 930 may be performed according to the methods described herein. In some examples, aspects of the operations of 930 may be performed by a PVM manager as described with reference to FIGS. 4 through 7.

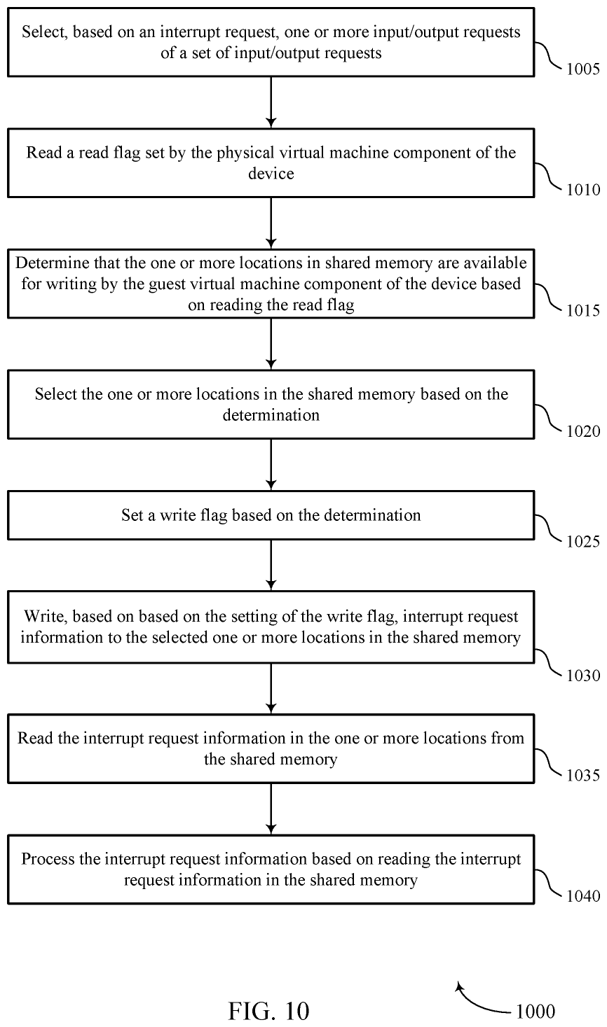

FIG. 10 shows a flowchart illustrating a method 1000 that supports shared memory buffers to submit an IRQ worklist to a back end VM in accordance with aspects of the present disclosure. The operations of method 1000 may be implemented by a device or its components as described herein. In some cases, the device may refer to a wireless device. For example, the operations of method 1000 may be performed by a virtualization manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 1005, the device may select, based on an interrupt request, one or more input/output requests of a set of input/output requests. The operations of 1005 may be performed according to the methods described herein. In some examples, aspects of the operations of 1005 may be performed by an IO request manager as described with reference to FIGS. 4 through 7.

At 1010, the device may read (e.g., by the guest virtual machine component of the device) a read flag (e.g., a read flag set by the physical virtual machine component of the device). The operations of 1010 may be performed according to the methods described herein. In some examples, aspects of the operations of 1010 may be performed by a GVM manager as described with reference to FIGS. 4 through 7.

At 1015, the device may determine that the one or more locations in shared memory (e.g., memory shared by the guest virtual machine component of the device and a physical virtual machine component of the device) are available for writing by the guest virtual machine component of the device based on reading the read flag. The operations of 1015 may be performed according to the methods described herein. In some examples, aspects of the operations of 1015 may be performed by a shared memory manager as described with reference to FIGS. 4 through 7.

At 1020, the device may select the one or more locations in the shared memory based on the determination (e.g., based on the read flag). The operations of 1020 may be performed according to the methods described herein. In some examples, aspects of the operations of 1020 may be performed by a GVM manager as described with reference to FIGS. 4 through 7.

At 1025, the device may set a write flag based on the determination. The operations of 1025 may be performed according to the methods described herein. In some examples, aspects of the operations of 1025 may be performed by a shared memory manager as described with reference to FIGS. 4 through 7.

At 1030, the device may write (e.g., by a guest virtual machine component of the device), based on based on the setting of the write flag, interrupt request information to the selected one or more locations in the shared memory. The operations of 1030 may be performed according to the methods described herein. In some examples, aspects of the operations of 1030 may be performed by a GVM manager as described with reference to FIGS. 4 through 7.

At 1035, the device may read (e.g., by the physical virtual machine component of the device) the interrupt request information in the one or more locations from the shared memory. The operations of 1035 may be performed according to the methods described herein. In some examples, aspects of the operations of 1035 may be performed by a PVM manager as described with reference to FIGS. 4 through 7.

At 1040, the device may process (e.g., by the physical virtual machine component of the device) the interrupt request information based on reading the interrupt request information in the shared memory. The operations of 1040 may be performed according to the methods described herein. In some examples, aspects of the operations of 1040 may be performed by a PVM manager as described with reference to FIGS. 4 through 7.

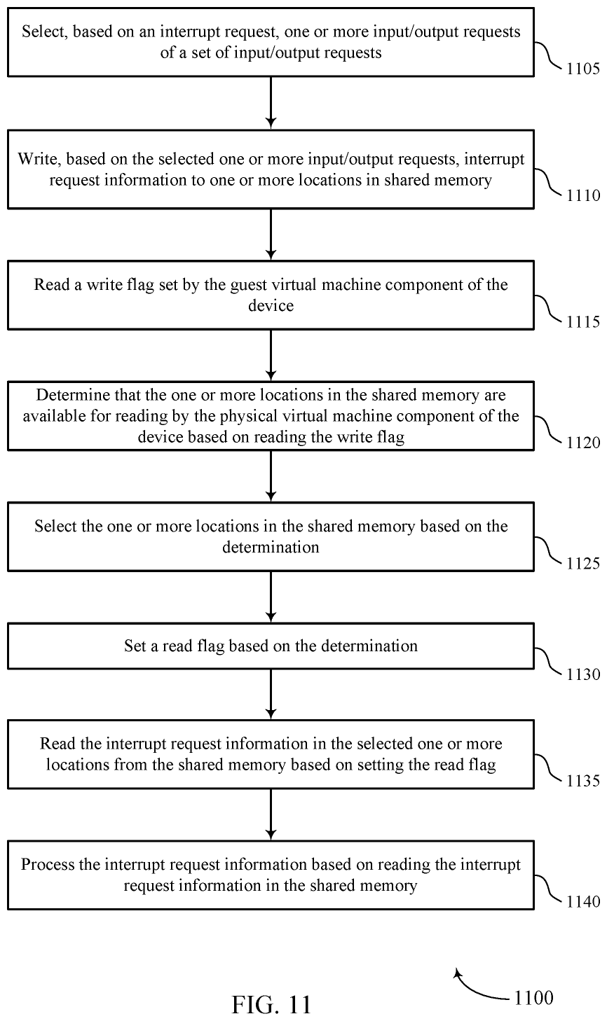

FIG. 11 shows a flowchart illustrating a method 1100 that supports shared memory buffers to submit an IRQ worklist to a back end VM in accordance with aspects of the present disclosure. The operations of method 1100 may be implemented by a device or its components as described herein. In some cases, the device may refer to a wireless device. For example, the operations of method 1100 may be performed by a virtualization manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 1105, the device may select, based on an interrupt request, one or more input/output requests of a set of input/output requests. The operations of 1105 may be performed according to the methods described herein. In some examples, aspects of the operations of 1105 may be performed by an IO request manager as described with reference to FIGS. 4 through 7.

At 1110, the device may write (e.g., by a guest virtual machine component of the device), based on the selected one or more input/output requests, interrupt request information to one or more locations in shared memory (e.g., memory shared by the guest virtual machine component of the device and a physical virtual machine component of the device). The operations of 1110 may be performed according to the methods described herein. In some examples, aspects of the operations of 1110 may be performed by a GVM manager as described with reference to FIGS. 4 through 7.

At 1115, the device may read (e.g., by the physical virtual machine component of the device), a write flag (e.g., a write flag set by the guest virtual machine component of the device). The operations of 1115 may be performed according to the methods described herein. In some examples, aspects of the operations of 1115 may be performed by a PVM manager as described with reference to FIGS. 4 through 7.

At 1120, the device may determine that the one or more locations in the shared memory are available for reading by the physical virtual machine component of the device based on reading the write flag. The operations of 1120 may be performed according to the methods described herein. In some examples, aspects of the operations of 1120 may be performed by a shared memory manager as described with reference to FIGS. 4 through 7.

At 1125, the device may select the one or more locations in the shared memory based on the determination (e.g., based on the write flag). The operations of 1125 may be performed according to the methods described herein. In some examples, aspects of the operations of 1125 may be performed by a shared memory manager as described with reference to FIGS. 4 through 7.

At 1130, the device may set a read flag based on the determination. The operations of 1130 may be performed according to the methods described herein. In some examples, aspects of the operations of 1130 may be performed by a shared memory manager as described with reference to FIGS. 4 through 7.

At 1135, the device may read (e.g., by the physical virtual machine component of the device), the interrupt request information in the selected one or more locations from the shared memory based on setting the read flag. The operations of 1135 may be performed according to the methods described herein. In some examples, aspects of the operations of 1135 may be performed by a PVM manager as described with reference to FIGS. 4 through 7.

At 1140, the device may process (e.g., by the physical virtual machine component of the device) the interrupt request information based on reading the interrupt request information in the shared memory. The operations of 1140 may be performed according to the methods described herein. In some examples, aspects of the operations of 1140 may be performed by a PVM manager as described with reference to FIGS. 4 through 7.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for virtualization at a device, comprising:
selecting, based at least in part on an interrupt request, one or more input/output requests of a set of input/output requests;
writing, by a guest virtual machine component of the device based at least in part on the selected one or more input/output requests, interrupt request information to one or more locations in memory shared by the guest virtual machine component of the device and a physical virtual machine component of the device;
reading, by the physical virtual machine component of the device, the interrupt request information in the one or more locations from the shared memory; and
processing, by the physical virtual machine component of the device, the interrupt request information based at least in part on reading the interrupt request information in the shared memory.

2. The method of claim 1, wherein writing the interrupt request information to the one or more locations in the shared memory comprises:
setting a write flag, writing a total number of work items, writing one or more work items, or any combination thereof to the one or more locations in the shared memory, wherein the total number of work items indicate a number of the selected one or more input/output requests and the each of the one or more work items corresponds to one of the one or more input/output requests.

3. The method of claim 2, wherein reading the interrupt request information in the one or more locations from the shared memory comprises:
setting a read flag, reading the total number of work items, reading each of the one or more work items, or any combination thereof.

4. The method of claim 3, further comprising:
updating, by the physical virtual machine component of the device, the total number of work items after each of the one or more work items are read; and
clearing the read flag after all of the one or more work items have been read.

5. The method of claim 1, further comprising:
reading, by the guest virtual machine component of the device, a read flag set by the physical virtual machine component of the device; and
selecting the one or more locations in the shared memory based at least in part on the read flag, wherein the interrupt request information is written based at least in part on the selected one or more locations in the shared memory.

6. The method of claim 5, further comprising:
identifying a starting worklist from a last write index, a last read index, or both, wherein the read flag is read based at least in part on the identified starting worklist.

7. The method of claim 5, further comprising:
determining that the one or more locations in the shared memory are available for writing by the guest virtual machine component of the device based at least in part on reading the read flag; and
setting a write flag based at least in part on the determination, wherein the interrupt request information is written based at least in part on the setting of the write flag.

8. The method of claim 1, further comprising:
reading, by the physical virtual machine component of the device, a write flag set by the guest virtual machine component of the device; and
selecting the one or more locations in the shared memory based at least in part on the write flag, wherein the interrupt request information is read based at least in part on the selected one or more locations in the shared memory.

9. The method of claim 8, further comprising:
identifying a starting worklist from a last write index, a last read index, or both, wherein the write flag is read based at least in part on the identified starting worklist.

10. The method of claim 8, further comprising:
determining that the one or more locations in the shared memory are available for reading by the physical virtual machine component of the device based at least in part on reading the write flag; and
setting a read flag based at least in part on the determination, wherein the interrupt request information is read based at least in part on the setting of the read flag.

11. The method of claim 1, wherein the interrupt request information comprises one or more work items that each comprise a retired information field, a context information field, a target timestamp information field, or any combination thereof.

12. The method of claim 11, further comprising:
clearing, by the guest virtual machine component of the device, the retired information field of a first work item of the one or more work items based at least in part on writing the first work item.

13. The method of claim 11, further comprising:
setting, by the physical virtual machine component of the device, the retired information field of a first work item of the one or more work items based at least in part on reading the first work item.

14. The method of claim 1, wherein the guest virtual machine component of the device comprises a front end component of the device and the physical virtual machine component of the device comprises a back end component of the device.

15. The method of claim 14, wherein the back end component accesses hardware of the device based at least in part on the set of input/output requests.

16. The method of claim 15, wherein the forwarding logic of the back end component is controlled based at least in part on the selection of the one or more input/output requests of the set of input/output requests.

17. The method of claim 16, wherein the one or more input/output requests are selected based at least in part on a frequency of the interrupt request.

18. An apparatus for virtualization at a device, comprising:
a processor, memory coupled with the processor; and
instructions stored in the memory and executable by the processor to cause the apparatus to:
select, based at least in part on an interrupt request, one or more input/output requests of a set of input/output requests;
write, by a guest virtual machine component of the device based at least in part on the selected one or more input/output requests, interrupt request information to one or more locations in memory shared by the guest virtual machine component of the device and a physical virtual machine component of the device;
read, by the physical virtual machine component of the device, the interrupt request information in the one or more locations from the shared memory; and
process, by the physical virtual machine component of the device, the interrupt request information based at least in part on reading the interrupt request information in the shared memory.

19. The apparatus of claim 18, wherein the instructions to write the interrupt request information to the one or more locations in the shared memory are executable by the processor to cause the apparatus to:
set a write flag, writing a total number of work items, writing one or more work items, or any combination thereof to the one or more locations in the shared memory, wherein the total number of work items indicate a number of the selected one or more input/output requests and the each of the one or more work items corresponds to one of the one or more input/output requests.

20. A non-transitory computer-readable medium storing code for virtualization at a device, the code comprising instructions executable by a processor to:
select, based at least in part on an interrupt request, one or more input/output requests of a set of input/output requests;
write, by a guest virtual machine component of the device based at least in part on the selected one or more input/output requests, interrupt request information to one or more locations in memory shared by the guest virtual machine component of the device and a physical virtual machine component of the device;
read, by the physical virtual machine component of the device, the interrupt request information in the one or more locations from the shared memory; and
process, by the physical virtual machine component of the device, the interrupt request information based at least in part on reading the interrupt request information in the shared memory.
